(19) United States
(12) Patent Application Publication
(10) Pub. No.: US 2012/0033406 A1
(43) Pub. Date: Feb. 9, 2012

(54) OVEN, ESPECIALLY DOMESTIC OVEN

(75) Inventors: Mirjam Zybok, Geslau (DE); Camila Siewert, Rothenburg o.d. Tauber (DE); Markus Junkersfeld, Rothenburg o.d. Tauber (DE)

(73) Assignee: ELECTROLUX HOME PRODUCTS CORPORATION N.V., Brussel (BE)

(21) Appl. No.: 13/263,178

(22) PCT Filed: Apr. 1, 2010
(86) PCT No.: PCT/EP10/02094

§ 371 Date: Oct. 6, 2011

(30) Foreign Application Priority Data
Apr. 30, 2009 (EP) 09005963.5

(51) Int. Cl. A21B 3/10

(52) U.S. Cl. 362/92

(57) ABSTRACT

The invention relates to an oven (1), especially to a domestic oven, having a cooking cavity (2) and means (3) for illuminating the cavity, wherein the means (3) for illuminating comprise a housing (4) for receiving a lamp (5), wherein at least a part of the housing (4) has a glass element (6) which is transparent for the light emitted by the lamp (5). To get a heat protection of the lamp or to support applications like pyrolysis, the invention is characterised in that the glass element (6) is covered by a heat reflecting layer (7).

The invention relates to an oven, especially to a domestic oven, having a cooking cavity and means for illuminating the cavity, wherein the means for illuminating comprise a housing for receiving a lamp, wherein at least a part of the housing has a glass element which is transparent for the light emitted by the lamp.

Ovens of this kind with a cavity which is illuminated by means for illumination are well known in the art. To ensure proper working conditions for the user of the oven the cavity must be duly illuminated. For doing so different solutions are known in the prior part.

DE 299 08 990 U1 shows an illumination system for the cavity of an oven, which has a reflector of a substantial prismatic shape. Within the reflector element a plurality of reflectors are arranged having a saddle-shaped form.

Other solutions for illuminating the cavity of the oven are shown in DE 38 08 717 A1, in EP 0 922 910 B1, in EP 0 513 758 A2 and in FR 2 826 707 A1.

It has been found detrimental that the lamp within the housing is exposed to a significant heat coming from the cavity during a cooking or baking process. The infrared radiation from the cavity heats up not only the lamp itself but also the other components of the means for illuminating, e. g. the bulb of the lamp itself, the socket, the lamp chassis and the electrical connection.

Consequently, the lamp and the mentioned parts become very hot due to the heat which comes from the cavity. Furthermore, the lamp and the mentioned parts are exposed to very high temperatures if a pyrolysis process is employed to clean the cavity. Thus, special lamps of high quality and high prices are necessary to be able to resist the high temperatures.

Therefore, it is an object of the invention to propose a concept for means for illumination of a cavity which can employ regular and thus cheap lamps for the illumination. This should even be possible if a pyrolysis process is operated in the cavity for cleaning.

The solution of this object according to the invention is characterized in that the glass element is covered by a heat reflecting layer.

The heat reflecting layer is preferably arranged at the side of the glass element which is directed to the cavity. The layer is preferably reflective for infrared radiation, i. e. for heat radiation which is created in the cavity.

The glass element is preferably coated with the heat reflecting layer.

The heat reflecting layer can consist of or can comprise titanium dioxide, barium sulphate, magnesium oxide and/or tantalum oxide. Also, other substances are suitable which protect against heat radiation.

The lamp is preferably free from any coating. Thus, regular lamps can be used.

The housing for receiving the lamp is normally mounted in a side region of the cavity or in a rear region of the cavity or in a top region or a bottom region of the cavity. Of course if more than one housings or lamps are to be provided those can be arranged also on more than one of these regions (side, rear, top, bottom) of the cavity.

Beneficially, it is possible to use cheaper lamps and cheaper lamp components, i. e. regular lamps and components which are not specifically designed to bear high temperatures. Also a pyrolysis process can be employed within the cavity without any danger that the lamp and the surrounding parts are heated up too much. Also it becomes possible to use lamps with a lower energy consumption.

In the drawings an embodiment of the invention is depicted.

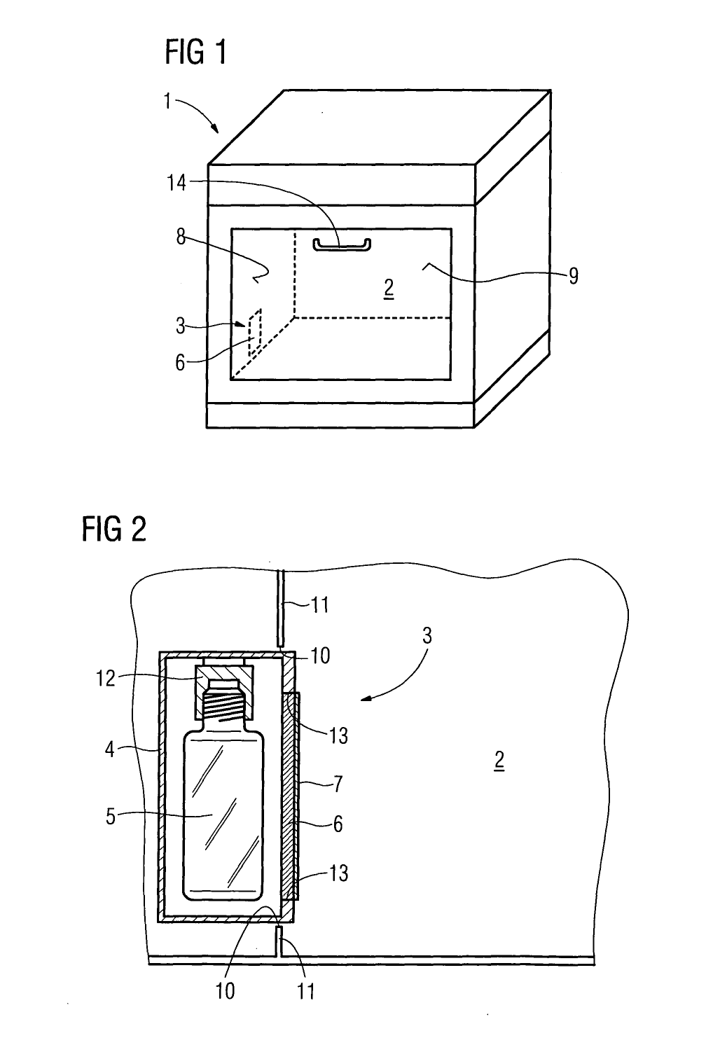

FIG. 1 shows a perspective view of a domestic oven, and

FIG. 2 shows a sectional view through the means for illuminating, which are arranged in the left side region of the cavity of the domestic oven according to FIG. 1.

In FIG. 1 a domestic oven 1 is depicted having a cooking cavity 2 as usual. The cavity 2 is closable by a door, from which only a grip 14 can be seen in FIG. 1. To illuminate the cavity 2 means 3 for illuminating are employed. Those means 3 are arranged on both side regions 8 of the cavity 2, remote from the rear wall, i. e. in the front region of the cavity 2.

The means 3 for illuminating the cavity 2 are depicted in detail in FIG. 2, where a cross sectional view through the means are depicted.

The means 3 for illuminating comprise a housing 4 which can be made from sheet metal. The housing 4 has a substantial cuboidal shape and is inserted into an opening 10 which is machined into a wall 11 which is delimiting the cavity 2.

Within the housing 4 an electrical lamp 5 is arranged, which is held by a socket 12 in a usual manner. The lamp 5 is a regular lamp, i. e. it is not equipped specifically to resist high temperatures. The lamp 5 is supplied with current via the socket 12 in a known manner.

The housing 4 has an opening 13 in which a glass element 6 is inserted. The glass element 6 is permeable for light; thus the light from the lamp 5 can illuminate the cavity 2.

To protect the lamp 5 as well as the socket 12 and other components of the means 3 for illuminating from the heat from the cavity 2, the glass element 6 is coated with a heat reflecting layer 7. Preferably the layer 7 is arranged at that side of the glass element 6 which adjoins to the cavity 2.

In the depicted embodiment of the invention the means 3 for illuminating are arranged in both side regions 8 of the cavity (see FIG. 1). Of course it is also possible to locate the means 3 in the rear region 9 or in the top or ceiling region or in the lower or bottom region of the cavity 2.

The heat reflecting layer 7 is made from a suitable material which has the desired effect.

A plurality of coatings can be employed having a high and low index of refraction. These coatings include, for example, TiO₂, Ta₂O₅ or Nb₂O₅, and SiO₂ respectively. Such coatings are described e. g. in U.S. Pat. No. 5,179,468 or in U.S. Pat. No. 5,138,219.

Depending on the dimension of the stack of the respective coatings, these coatings can be used as cold-light mirrors as well as warm-light mirrors or as wide-band mirrors. Details of this solution are described in U.S. Pat. No. 4,663,557.

### Reference Numerals

1 Oven (domestic oven)
2 Cooking cavity
3 Means for illuminating
4 Housing
5 Lamp
6 Glass element
7 Heat reflecting layer
8 Side region of the cavity
9 Rear region of the cavity
10 Opening
11 Wall
12 Socket
13 Opening
14 Grip

1. Oven (1), especially domestic oven, having a cooking cavity (2) and means (3) for illuminating the cavity, wherein the means (3) for illuminating comprise a housing (4) for receiving a lamp (5), wherein at least a part of the housing (4) has a glass element (6) which is transparent for the light emitted by the lamp (5), characterized in that the glass element (6) is covered by a heat reflecting layer (7).

2. Oven according to claim 1, characterized in that the heat reflecting layer (7) is arranged at the side of the glass ele -ment (6) which is directed to the cavity (2).

3. Oven according to claim 1, characterized in that the heat reflecting layer (7) is reflective for infrared radiation.

4. Oven according to claim 1, characterized in that the glass element (6) is coated with the heat reflecting layer (7).

5. Oven according to claim 1, characterized in that the heat reflecting layer (7) consists of or comprises titanium dioxide.

6. Oven according to claim 1, characterized in that the heat reflecting layer (7) consists of or comprises barium sulfate.

7. Oven according to claim 1, characterized in that the heat reflecting layer (7) consists of or comprises magnesium oxide.

8. Oven according to claim 1, characterized in that the heat reflecting layer (7) consists of or comprises tantalum oxide.

9. Oven according to claim 1, characterized in that the lamp (5) is free from any coating.

10. Oven according to claim 1, characterized in that the housing (4) for receiving the lamp (5) is mounted in a side region (8) of the cavity (2).

11. Oven according to claim 1, characterized in that the housing (4) for receiving the lamp (5) is mounted in a rear region (9) in the top or ceiling region or in the lower or bottom region of the cavity 2of the cavity (2).

12. Oven according to claim 1, characterized in that the housing (4) for receiving the lamp (5) is mounted in a top or ceiling region or in a lower or bottom region of the cavity (2).
